(19) United States
(12) Patent Application Publication
(10) Pub. No.: US 2011/0179767 A1
(43) Pub. Date: Jul. 28, 2011

(54) COOLING DEVICE FOR AIRCRAFT PROPELLER

(75) Inventors: Christelle RINJONNEAU, Toulouse (FR); Pierre GUILLAUME, Toulouse (FR)

(73) Assignee: AIRBUS OPERATIONS (S.A.S), Toulouse (FR)

(21) Appl. No.: 13/013,319

(22) Filed: Jan. 25, 2011

(30) Foreign Application Priority Data
Jan. 26, 2010 (FR) 10 50507

(51) Int. Cl. F02C 6/00

(52) U.S. Cl. 60/224

(57) ABSTRACT

The invention relates to an aircraft propeller (1) comprising a turbomachine (8) housed in a nacelle (10) and a cooler (45) capable of being traversed by a hot fluid, which is to be cooled by thermal exchange with cold air external to the cooler. The propeller (1) comprises an air stream (13) (13b) capable of directing pressurized air towards an air duct (20) realized between an outer wall (6) and an inner wall (60) of the nacelle (10). The cooler comprises volumetric cooling means (14) located in the air duct (20) and surface cooling means (15), unrelated to said volumetric cooling means, located at an outside wall (6, 101) of the aircraft.

The present invention relates to a turbomachine-type aircraft propeller. More specifically, the invention relates to a cooling device for propellers.

In aviation, a large number of aircraft propellers comprise a turbomachine, housed in a nacelle.

One can cite the case, for example, of turbofan-type propellers for which the turbomachine drives at least one rotor located inside the nacelle. One can also cite the case of “propfan” or “open rotor” type propellers, for which the turbomachine drives two counter-rotating rotors, the two rotors being located outside the nacelle, downstream or upstream of the turbomachine.

Whatever the type of propellers, a gear box (gears between the turbomachine shaft and the rotors) transmits the mechanical energy generated by the turbomachine to the rotors.

Although it has very high efficiency, this gearbox dissipates part of the energy created by the propeller into heat by friction. This heat is transmitted in particular to the gearbox lubrication fluid.

Moreover, the turbomachine itself generates significant heat dissipation mainly by mechanical friction, also through its lubricating fluid.

It is clear that this heat must be dissipated to the outside environment to cool the propeller.

Equipment mounted on the turbomachine, such as an electric generator, may also require cooling.

Various solutions have been developed to perform this cooling.

A first known solution, mainly for turbofan-type propellers, is to install a heat exchanger, known as a “volumetric heat exchanger”, between an outer wall and an inner wall of the nacelle. An air inlet collects cold air from the cold air flow going through the turbomachine, to bring it inside said volumetric heat exchanger. After passing through the heat exchanger matrix, the air is ejected out of the nacelle through an air outlet. Such heat exchangers have not proved to be an optimal solution in terms of propulsive efficiency and of aerodynamic impact on the turbomachine. In effect, the air collection represents a direct loss of propulsive efficiency inasmuch as it contributes little or nothing to the engine's thrust. Moreover, the presence of an air inlet, one or more internal ducts and an air outlet generates load losses and disturbs the propeller's internal flow more or less significantly.

Another known solution is to use an exchanger, known as a “surface exchanger”, e.g. a plate heat exchanger. In particular, a surface exchanger is known that locally takes the shape of an inner wall of the nacelle or of the engine cover to which it is coupled. A first surface of the surface exchanger is coupled to the inner wall of the nacelle or of the engine cover, while a second surface is located in the flow of cold air flowing through the internal volume of the nacelle. The heat transported within the heat exchanger is transferred by thermal conduction to the inner surface of the plate forming the lower surface of the plate heat exchanger. This hot plate is traversed by the flow of cold air flowing in the nacelle. The heat stored in the hot plate on the inner surface is thus dissipated by forced convection towards the propeller's airflow.

This solution still has an aerodynamic impact, but has the advantage, compared to the previous solution, of not collecting air from the flow through the turbomachine.

However, this solution cannot be transposed to propfan-type propellers. Indeed, when the aircraft speed is low or zero, there is little or no air flow traversing the surface exchanger, because the rotors are arranged outside the nacelle.

The objective of this invention is therefore to provide an propeller comprising a turbomachine cooling device that overcomes the aforementioned drawbacks by ensuring an adequate level of cooling on the ground and in flight while limiting the aerodynamic impact during flight phases.

To this end, the invention envisages an aircraft propeller comprising a turbomachine housed in a nacelle and a cooler capable of being traversed by a hot fluid, which is to be cooled by thermal exchange with cold air external to the cooler. The propeller comprises an air stream capable of directing pressurized air towards an air duct realized between an outer wall and an inner wall of the nacelle. The cooler comprises:
volumetric cooling means positioned in the air duct,
surface cooling means, unrelated to said volumetric cooling means, arranged at an outer wall of the aircraft.

The hot fluid to be cooled is, for example, lubricating oil for the gearbox and/or engine.

“Unrelated” means that the two cooling means are not adjacent to each other but separate and connected only by means of conduction of the hot fluid, e.g. oil circuits.

In other words, the cooler works in two possible modes: firstly as a volumetric heat exchanger by providing a large contact area to the fluid and secondly as a surface heat exchanger.

The choice of cooling the oil by means of volumetric and/or surface cooling may depend on flight parameters, such as for example, the flight phase and/or engine speed and/or airplane Mach number, and/or the aircraft's operating parameters, such as for example, oil temperature.

In this description, the choice will be based on the aircraft's flight phases.

Preferably, the surface cooling means is sized so as to be sufficient to ensure the desired cooling by itself when the aircraft is in flight, within preselected environmental and speed conditions, and the volumetric cooling means is sized so as to be sufficient to ensure by itself the desired cooling when the aircraft is at low or zero speed, within preselected environmental conditions.

Throughout the description, “upstream” shall designate, at a given point, the part that is placed in front of this point by reference to the direction of the airflow in the propeller, and “downstream” shall designate the part that is located behind this point.

In a first embodiment, a pressurized air inlet is located at a 1^{st} stage of an air compressor of the turbomachine and the associated air stream emerges upstream of the volumetric cooling means, so as to allow the volumetric cooling means to be traversed by the pressurized air.

According to another embodiment of the invention, a pressurized air inlet is located downstream from an air compressor of the turbomachine and the associated air stream emerges downstream from the volumetric cooling means, so to allow the creation of suction at the exit of the volumetric cooling means.

Advantageously, the air stream comprises, at the air duct 20, a small diameter pipe or ejector, which ejects pressurized air into said air duct.

According to another embodiment of the invention, the propeller comprises two air streams and a valve associated with each stream, an air stream emerging upstream of the cooler and an air stream emerging downstream from the cooler, the valves controlling the entry of pressurized air according to one air stream or the other.

Preferably, the surface cooling means is installed at the outer wall of the nacelle or at an outer wall of a mounting pylon of said propeller.

If the available area of the surface cooling means is sufficient, said surface cooling means may present a flat surface to minimize its aerodynamic impact.

In a preferred embodiment of the surface cooling means, said surface cooling means is a set of fins extending from the outer wall of the nacelle or propeller pylon and directed mainly parallel to the direction of airflow when the aircraft is on the ground.

Alternatively, the air duct comprises an air inlet installed substantially at the front of the propeller nacelle so as to create an additional air inlet. Thus, cold air from outside of the propeller and pressurized air from the air compressor traverse the volumetric cooling means.

Preferably, the air duct comprises an air outlet comprising means of closing. The means of closing is preferably in the closed position when the aircraft is in flight so as to overcome the drag caused by the air duct.

The invention also envisages an aircraft comprising a propeller as set forth.

The description that will follow, given solely as an example of an embodiment of the invention, is made with reference to the figures included in an appendix, in which:

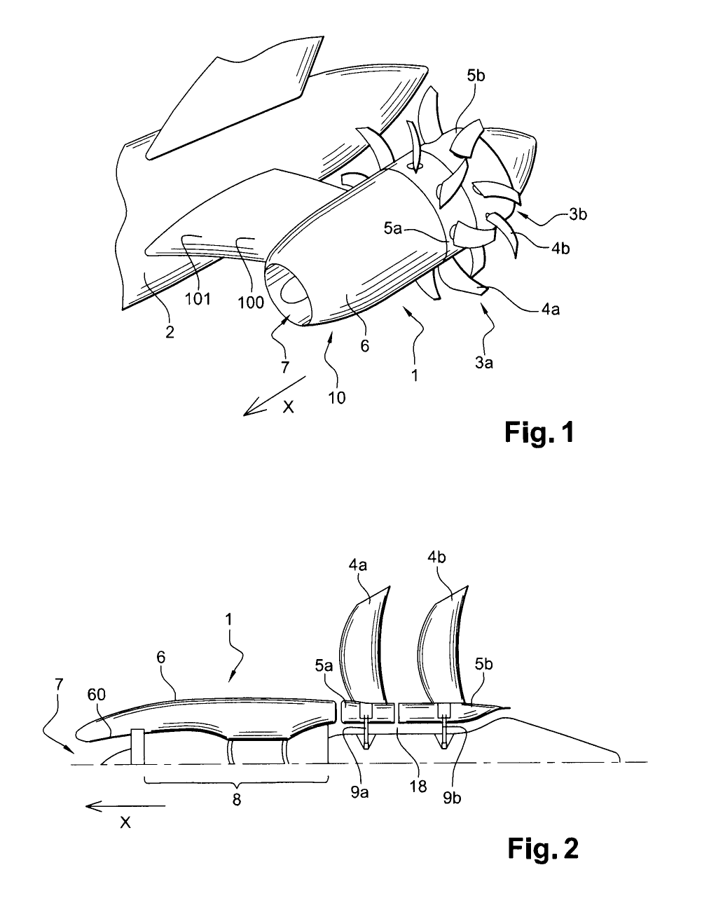

FIG. 1 shows an propeller of a type called “propfan,” to which the invention can be applied,

FIG. 2 illustrates such an propeller in a very schematic cross-section view,

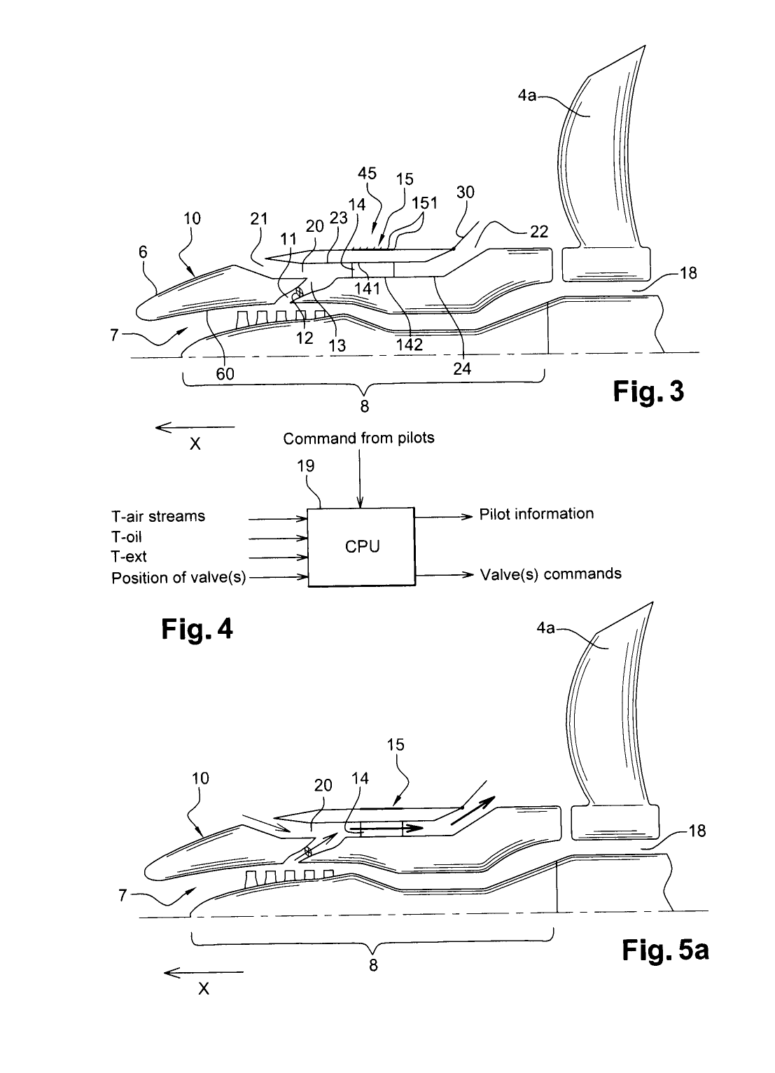

FIG. 3 is a detail view of FIG. 2, centered on the front part of the propeller, which highlights the main elements of a cooling device according to a first embodiment of the invention,

FIG. 4 illustrates schematically the data processed by an electronic control of the cooling device according to the invention,

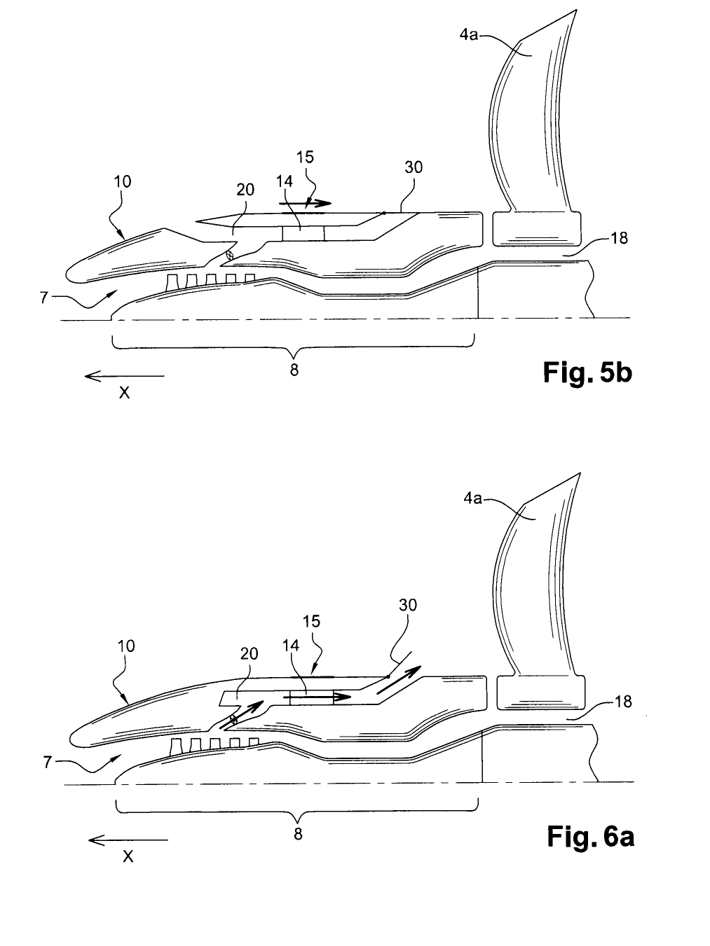

FIG. 5a shows in a detail view the airflow in the cooler when the aircraft is at low speed, for the first embodiment of the invention,

FIG. 5b shows in a detail view the airflow in the cooler when the aircraft is in the air, for the first embodiment of the invention,

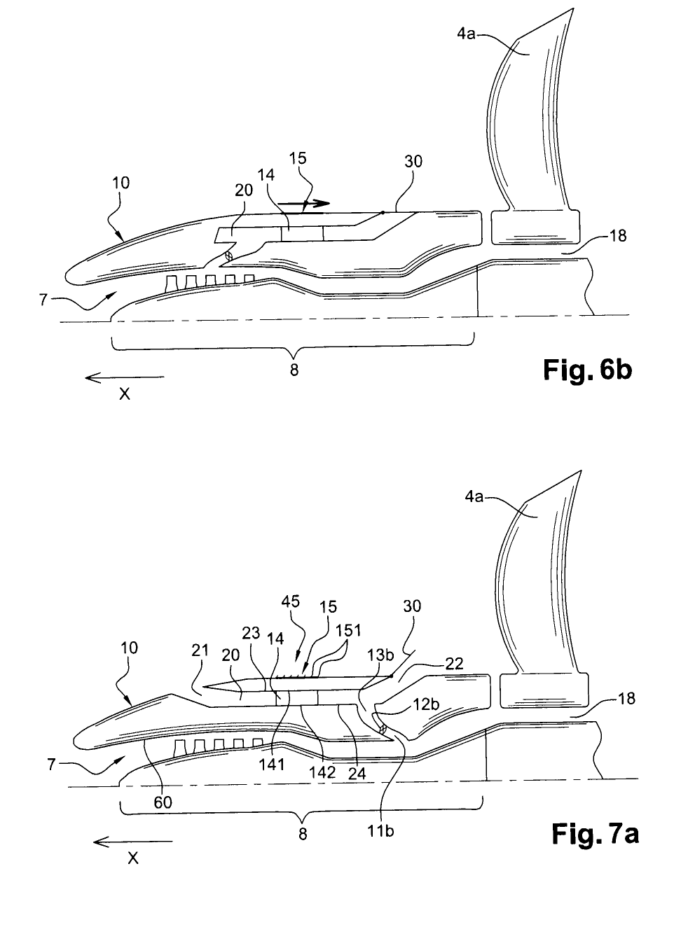

FIG. 6a shows in a detail view the airflow in the cooler when the aircraft is at low speed, according to a variant of the first embodiment of the invention,

FIG. 6b shows in a detail view the airflow in the cooler when the aircraft is in flight, according to a variant of the first embodiment of the invention,

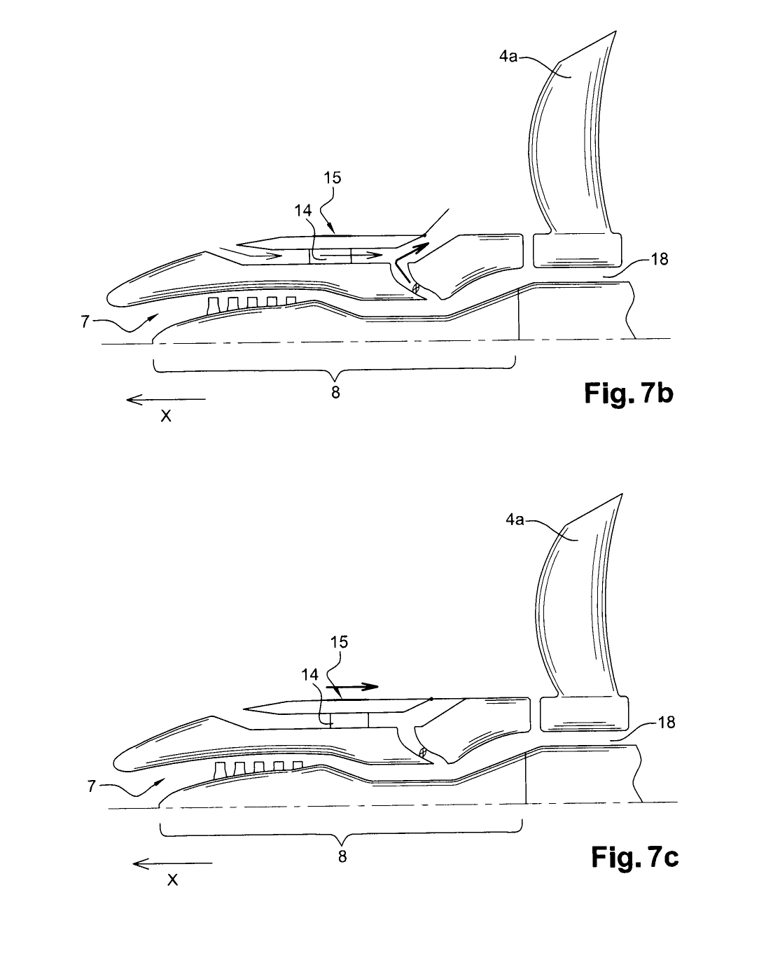

FIG. 7a is a detail view of FIG. 2, centered on the front part of the propeller, which highlights the main elements of the cooling device according to a second embodiment of the invention,

FIG. 7b shows in a detail view the airflow in the cooler when the aircraft is at low speed, for the second embodiment of the invention,

FIG. 7c shows in a detail view the airflow in the cooler when the aircraft is in the air, for the second embodiment of the invention,

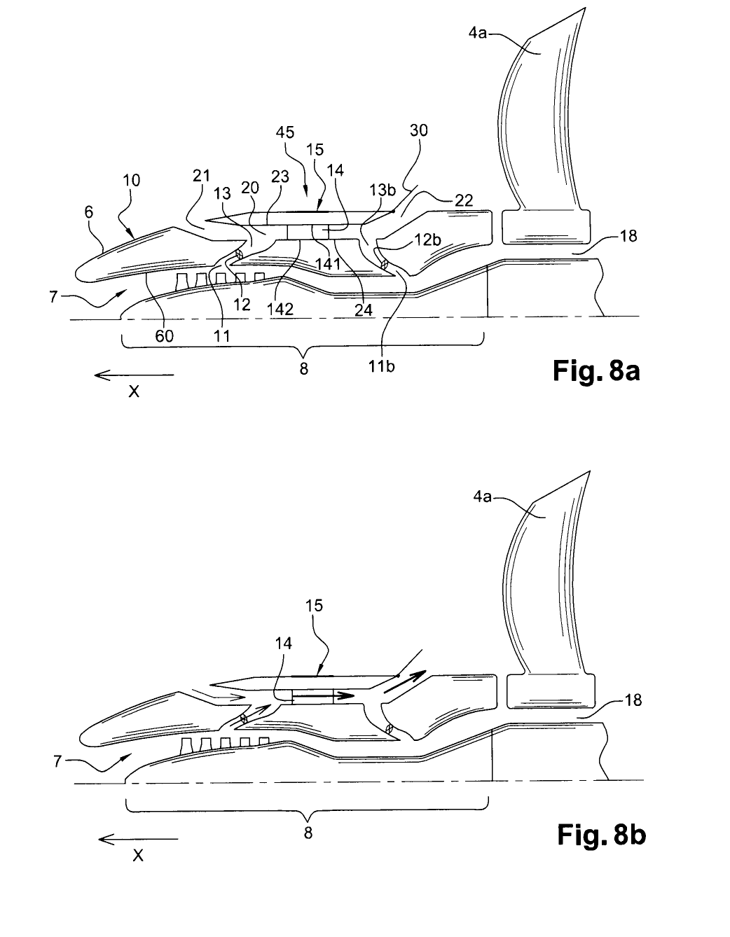

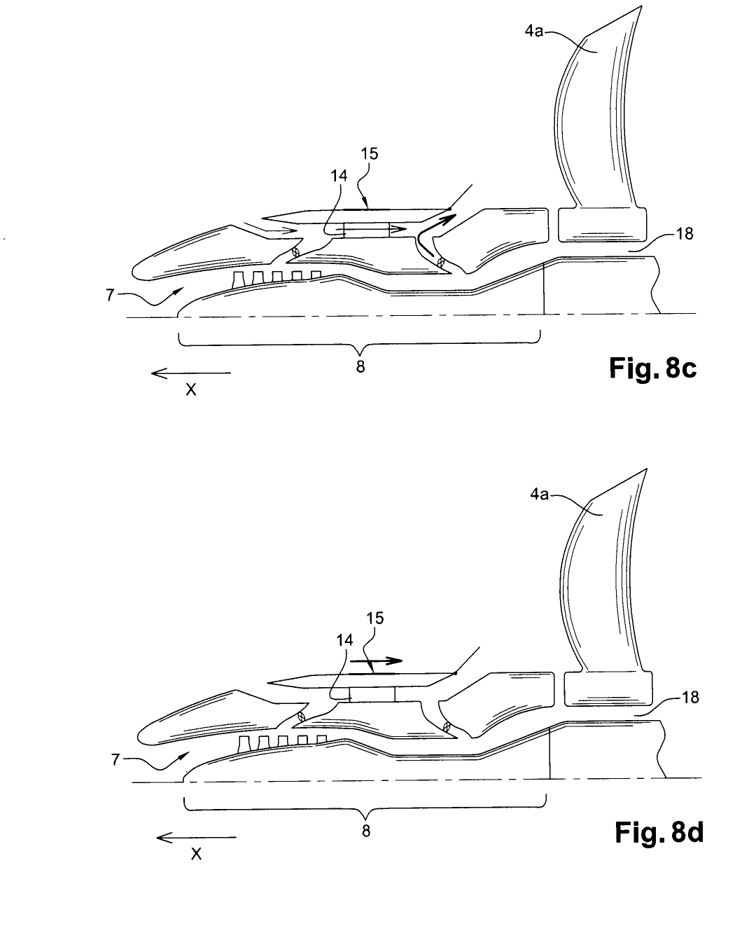

FIG. 8a is a detail view of FIG. 2, centered on the front part of the propeller, which highlights the main elements of the cooling device according to a third embodiment of the invention,

FIG. 8b shows in a detail view a first example of airflow in the cooler when the aircraft is at low speed, for the third embodiment of the invention,

FIG. 8c shows in a detail view a second example of airflow in the cooler when the aircraft is at low speed, for the third embodiment of the invention,

FIG. 8d shows in a detail view the airflow in the cooler when the aircraft is in the air, for the third embodiment of the invention,

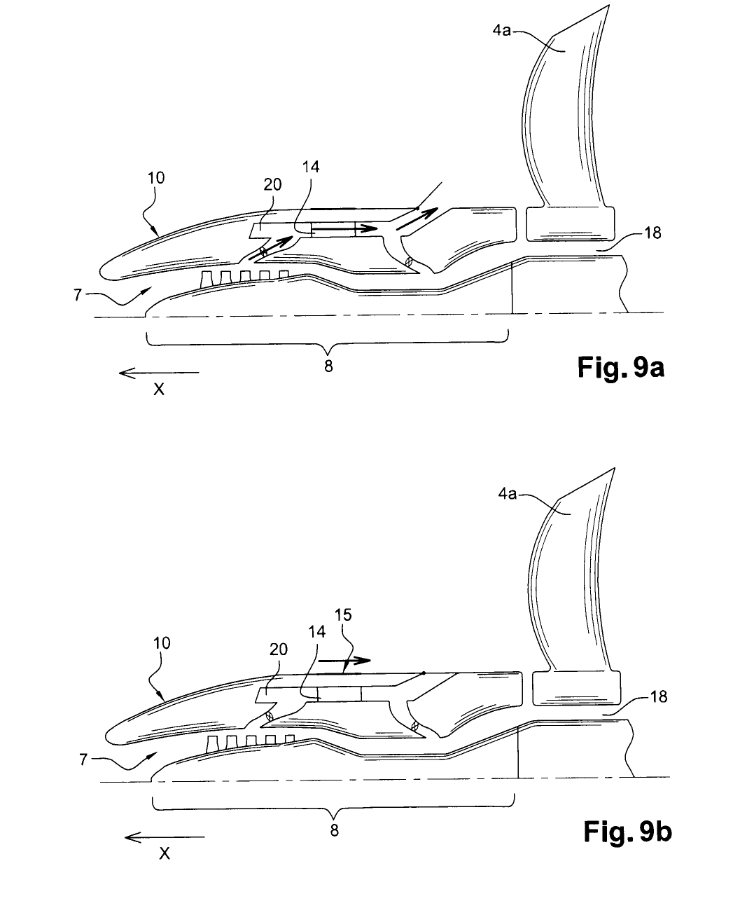

FIG. 9a shows in a detail view the airflow in the cooler when the aircraft is at low speed, according to a variant of the third embodiment of the invention,

FIG. 9b shows in a detail view the airflow in the cooler when the aircraft is in flight, according to a variant of the third embodiment of the invention.

The invention relates to an aircraft propeller 1, for example of the type called “propfan” as shown in FIG. 1. In the example of implementation illustrated here, two propfan propellers 1, each housed in a nacelle 10, are attached by mounting pylons 100, on both sides of an aircraft fuselage 2.

Each propfan propeller 1 comprises here two counter-rotating rotors 3a, 3b each comprising a set of blades 4a, 4b, which are equidistant and arranged at the rear of the propeller 1. The blades 4a, 4b of each rotor 3a, 3b protrude from an annular crown 5a, 5b, which is mobile with this rotor, an outer surface of which is located in the continuity of an outer wall 6 of the propeller nacelle.

As shown schematically in FIG. 2 the propfan propeller 1 comprises an air inlet 7 that supplies a turbomachine 8. This turbomachine 8 comprises an axial portion driven in rotation when the turbomachine is running. In turn, this shaft drives the shafts 9a, 9b of the blades 4a, 4b of the two counter-rotating rotors 3a, 3b via mechanical transmissions not shown in FIG. 2.

The hot gases generated by the turbomachine 8 when in operation are discharged through an annular hot stream 18 having an outlet located at the rear of the two rotors 3a, 3b. In a variant, these gases can also be discharged upstream of the two rotors.

The turbomachine 8 comprises, conventionally, a multistage compressor allowing incremental increases in the pressure of air entering the turbomachine.

The construction details of propfan propellers and their components—rotors, turbomachine, transmission—as well as their dimensions, materials etc. are beyond the scope of the present invention. The elements described here are therefore provided only for information purposes, to facilitate understanding of the invention in one of its non-limiting examples of implementation.

During the aircraft's flight, the outside air, whose temperature is between +55° C. near the ground and −74° C. at altitude, circulates along the outer wall 6 of the propeller's nacelle 10, substantially in the direction opposite to a longitudinal axis X of movement of the aircraft.

At the same time, the propeller generates a significant heat rejection, part of which is discharged through the annular hot stream 18, and another part, which is transmitted to the engine and gearbox oil circuits, must be discharged by an appropriate cooling device.

General Description

The cooling device comprises, as shown in FIG. 3, a cooler 45 comprising firstly volumetric cooling means 14 and secondly surface cooling means 15. The two cooling means 14, 15 are not connected to each other.

The volumetric cooling means 14 is positioned in an air duct 20 realized between the outer wall 6 and an inner wall 60 of the nacelle 10.

In an embodiment of the air duct, as shown in FIG. 3, the air duct 20 firstly emerges at the front of the propeller nacelle by an air inlet 21, near the main air inlet 7 and secondly emerges outside the nacelle by an air outlet 22, upstream of the rotors.

The volumetric cooling means 14 is intended to operate at low speed, for example on the ground and during take-off when the outside air flow is low or zero and a heat exchange carried out over a large area formed in a small volume is preferable.

The volumetric cooling means 14 is arranged in this example such that
a first outer surface 141 extends a first wall 23 of the air duct 20, by replacing this first wall locally,
a second outer surface 142 opposite the first outer surface 141 extends a second wall 24 of the air duct 20, by replacing this second wall locally.

The shape of the volumetric cooling means 14 is generally parallelepiped, in any case determined by the shape of the first 23 and second 24 walls where the volumetric cooling means 14 must be installed.

Preferably, the first and second outer surfaces 141, 142, and therefore the first and second walls of the air duct are substantially parallel one to the other.

The dimensions of the volumetric cooling means 14 are determined by the cooling requirement when the aircraft is on the ground or at low speeds, by the flow of outside air and the exchange surface formed within the volumetric cooling means 14. The calculation itself is known to the man skilled in the art and is therefore not detailed further here.

In an example of realization of the volumetric cooling means 14, said volumetric cooling means comprises a set of channels (not shown in the figures) for the passage of outside air.

The cooling means 14 is composed, for example, of assembled strips, which thus define the outside air passage channels.

In one embodiment, the channels are substantially parallel to one another and to the first and second outer surfaces 141, 142.

The volumetric cooling means 14 is made of a material with high heat conductivity, e.g. a metal alloy or composite material suitable for this purpose.

The surface cooling means 15 is designed to operate at high speed during flight phases, when the flow of outside air is significant and allows heat exchange over a small area.

The surface cooling means 15 is installed at an outer wall of the aircraft, for example the outer wall 6 of the nacelle, or an outer wall 101 of the mounting pylon 100 of the propeller.

In this non-limiting example of the invention, the surface cooling means 15 is installed at the outer wall 6 of the nacelle 10, near the volumetric cooling means 14.

Preferably, the surface cooling means 15 forms part of the outer wall 6 of the nacelle 10. The shape of the surface cooling means 15 is determined by the shape of the outer wall 6 of the nacelle 10 where the surface cooling means 15 must be installed.

In an example of realization of the surface cooling means 15, said surface cooling means comprises a set of fins 151 starting from the outer wall 6 of the nacelle and protruding on the outer wall 6 of the nacelle 10.

For example, these fins 151 can increase the exchange area, and are directed substantially parallel to the flow lines of an air stream flowing over the outer surface 6 of the nacelle 10 when the aircraft is in flight, i.e. substantially along the longitudinal axis X.

The dimensions of these fins 151 are determined by the cooling requirement when the aircraft is in flight or at low speed, and by the external air flow and the temperature of the air flowing along the surface of these fins. The details of such a calculation are known to the man skilled in the art.

The surface cooling means 15 and volumetric cooling means 14 are known to the man skilled in the art and will not be developed further here.

The cooling device is also controlled by an electronic control unit 19 (shown in FIG. 4), of a type known per se.

In this non-limiting example, said electronic control unit 19 receives oil circuit temperature data that the cooling device must regulate, as well as outside air temperature data as inputs.

Said electronic control unit 19 transmits control data, e.g. temperature of the oil circuits, to the aircraft's cockpit, from which it also receives instructions.

This electronic control unit 19 may be installed at the propeller 1, for example close to the volumetric cooling means 14 or surface cooling means 15. Alternatively, the electronic control unit 19 may be part of the various pieces of electronic equipment located in the cockpit, or simply be one of the functions provided by a multi-purpose computer usually found in aircraft.

In a variant of realization, the cooling device comprises a regulator valve (not shown in the figures), called oil flow regulator valve, designed to direct the flow of oil to be cooled either towards the volumetric cooling means 14 or towards the surface cooling means 15, depending on the speed, low or high, of the aircraft. Said oil flow regulator valve for is set by the electronic control unit 19.

In a variant of embodiment of the invention, the air duct 20 comprises, located at the air outlet 22, means of closing 30 said outlet. This means of closing is set by the electronic control unit 19.

In an example of realization, the means of closing 30 is a valve.

### First Embodiment

In a first embodiment of the cooling device, said cooling device, as shown in FIGS. 3, 5a and 5b, takes advantage of the presence of the compressor, and comprises an air inlet 11 of a type known per se, installed in this non-limiting example, at a first stage of the compressor of the turbomachine 8. This arrangement is intended to provide air that is as yet little warmed by compression, instead of the air located at the following stages of the compressor.

The position of the collection point naturally depends on the specific characteristics of the turbomachine 8 under consideration and of its compressor, but this position is imposed by the requirement for air at a pressure sufficient to bring a predefined flow of air to the cooler 45 at a sufficiently low temperature, while not disturbing the correct operation of the compressor and more generally of the turbomachine 8.

Preferably, this air inlet 11 comprises a regulator valve 12, here illustrated schematically, designed to control the flow of pressurized air collected at the air inlet 11 from a value close to zero to a maximum value determined by the cooling requirement of the gearbox and/or engine and/or electrical generator oil.

An air stream 13 located downstream from the regulator valve 12 leads the flow of collected pressurized air towards the air duct 20 upstream of the volumetric cooling means 14.

The electronic control unit 19 sets the regulator valve 12 according to various input information. It receives temperature data from air in the stream 13 and regulator valve 12 status information.

In operation, when the aircraft is on the ground or in taxiing, takeoff or approach phases, with the propellers operating, the thermal discharge from the propulsion group is very large and the aircraft speed is low or zero.

During these phases, called low speeds phases, the flow of outside air is low and insufficient for cooling by the volumetric cooling means 14 and surface cooling means 15.

The electronic control unit 19 sets the regulator valve 12 substantially into the maximum open position, allowing the volumetric cooling means 14 to be traversed by outside air and pressurized air collected at the compressor. The cooling is performed by both the volumetric cooling means 14 and surface cooling means 15, mainly by the volumetric cooling means 14.

This ensures a heat exchange between the hot volumetric cooling means 14, the outside air and the cold pressurized air, causing the desired cooling of the volumetric cooling means 14 and of the oil circulating within or connected to it by thermal conduction.

As the climb progresses and evolves towards level flight, the speed of the aircraft increases and the outside air temperature decreases. Accordingly, the collection of air at the compressor is reduced by gradual closing of the regulator valve 12 controlled by the electronic control unit 19 and the cooling is performed increasingly firstly by the surface cooling means 15 traversed by the outside air and secondly by the volumetric cooling means 14 traversed by the outside air flowing naturally into the air duct 20.

The closing (and by extension, the opening) of the valve 12 is described to be gradual but it is also possible that the closing (and by extension, the opening) of the valve is controlled in an on-or-off manner.

Subsequently, when the aircraft is in steady flight, the cooling is performed normally by the volumetric cooling means 14 and the surface cooling means 15, mainly by the surface cooling means 15, and the regulator valve 12 then remains closed, thereby eliminating the air collection from the compressor, and therefore reducing the increased fuel consumption that otherwise arises from this power draw.

When the air duct 20 comprises the means of closing 30, the electronic control unit 19 preferably sets the means of closing in the closed position during flight phases. In closed position, the means of closing 30 limits the impact of aerodynamic drag.

In a variant of the first embodiment, when the cooling device comprises the oil flow regulator valve, the electronic control unit 19 sets said oil flow regulator valve so as to direct the flow of oil only to the volumetric cooling means 14. The cooling is then performed only by the volumetric cooling means 14 (FIG. 5a).

As the climb progresses and evolves towards level flight, the electronic control unit 19 gradually sets the oil flow regulator valve to direct the flow of oil to the surface cooling means 15.

When the aircraft is in steady flight, the cooling is performed only by the surface cooling means 15 (FIG. 5b) and the regulator valve 12 then remains closed.

When the air duct 20 comprises the means of closing 30, the electronic control unit 19 preferably sets the means of closing in the closed position during flight phases. In closed position, the means of closing 30 limits the impact of aerodynamic drag.

In another variant of the first embodiment, as shown in FIGS. 6a and 6b, the air duct 20 does not emerge, for example using means of closing air inlet 21, toward the front of the nacelle 10, so as to reduce the aerodynamic drag caused by the air inlet.

During the low speed phases, the electronic control 19 sets the regulator valve 12 into substantially maximum open position and pressurized cold air flows through the air duct 20. The volumetric cooling means 14 and surface cooling means 15 are in operation.

When the cooling device comprises the oil flow regulator valve, the electronic control unit 19 sets said oil flow regulator valve to direct the flow of oil to the volumetric cooling means 14. Only the volumetric cooling means 14 is in operation and is traversed by pressurized air collected at the compressor (shown in FIG. 6a).

When the air duct 20 further comprises the means of closing 30 of the air outlet 22, said means of closing is in the open position.

During the flight phase, the electronic control unit 19 sets the regulator valve 12 into the closed position and the oil cooling is performed only by the surface cooling means 15.

When the cooling device comprises the oil flow regulator valve, the electronic control unit 19 sets said oil flow regulator valve so as to direct the flow of oil to the surface cooling means 15. Only the volumetric cooling means 15 is in operation and is traversed by outside air (FIG. 6b).

When the air duct 20 comprises the means of closing 30 of the air outlet 22, said means of closing is preferably in the closed position.

### Second Embodiment

In a second embodiment of the cooling device, as shown in FIGS. 7a to 7c, said cooling device comprises an air inlet 11b, of a type known per se, installed, in this non-limiting example, downstream from the compressor of the turbomachine 8.

Preferably, this air inlet 11b comprises a regulator valve 12b, here illustrated schematically, designed to control the flow of pressurized air collected at the air inlet 11b from a value close to zero to a maximum value determined by the cooling requirement of the gearbox and/or engine and/or electrical generator oil.

An air stream 13b installed downstream from the regulator valve 12b drives the collected flow of pressurized air into the air duct 20 formed in the nacelle 10, downstream from the volumetric cooling means 14, and creates suction of outside air from the air inlet 21 into the air duct, passing through said volumetric cooling means 14.

Advantageously, the air stream 13b ends, at the air duct 20, in a small diameter pipe or ejector (not shown in the figures), which ejects pressurized air into the air duct 20. The ejection of the pressurized air produces an acceleration of the external airflow coming from the air duct 20 by a suction phenomenon and consequently an increase in the air flow through the volumetric cooling means 14.

In this second embodiment, the electronic control unit 19 sets the regulator valve 12b according to various input information. It receives temperature data from air in the air stream 13b and regulator valve 12b status information.

In operation, when the aircraft is in low speed phases, the propulsion group thermal discharge is very large and the aircraft speed is low or zero.

During these low speeds phases, the flow of outside air is low and insufficient for cooling by the volumetric cooling means 14 and surface cooling means 15.

The electronic controller 19 sets the regulator valve 12b substantially in the maximum open position, to create suction of outside air through the volumetric cooling means 14 at the exit of the air duct. The cooling is performed by both the volumetric cooling means 14 and surface cooling means 15, mainly by the volumetric cooling means 14.

This ensures a heat exchange between the hot volumetric cooling means 14, the outside air and the cold pressurized air, causing the desired cooling of the volumetric cooling means 14 and of the oil circulating within or connected to it by thermal conduction.

As the climb progresses and evolves towards level flight, the speed of the aircraft increases and the outside air temperature decreases. Accordingly, the collection of air at the compressor is reduced by gradually closing the regulator valve 12b controlled by the electronic control unit 19 and the cooling is performed increasingly firstly by the surface cooling means 15 traversed by the outside air and secondly by the volumetric cooling means 14 traversed by the outside air flowing naturally into the air duct 20.

The closing (and by extension, the opening) of the valve 12b is described as being gradual but it is also possible that the closing (and by extension, the opening) of the valve is controlled in an on-or-off manner.

Subsequently, when the aircraft is in steady flight, the cooling is performed normally by the volumetric cooling means 14 and the surface cooling means 15, mainly by the surface cooling means 15, and the regulator valve 12b then remains closed, thereby eliminating the air collection from the compressor, and therefore reducing the increased fuel consumption that otherwise arises from this power draw.

When the air duct 20 comprises the means of closing 30, the electronic control unit 19 preferably sets the means of closing in the closed position during flight phases. In closed position, the means of closing 30 limits the impact of aerodynamic drag.

In a variant of the second embodiment, when the cooling device comprises the oil flow regulator valve, the electronic control unit 19 sets said oil flow regulator valve to direct the flow of oil only to the volumetric cooling means 14. The oil cooling is then performed only by the volumetric cooling means 14 (FIG. 7b).

As the climb progresses and evolves towards level flight, the electronic control unit 19 gradually sets the oil flow regulator valve to direct the flow of oil to the surface cooling means 15.

When the aircraft is in steady flight, the cooling is performed only by the surface cooling means 15 (FIG. 7c) and the regulator valve 12b then remains closed.

When the air duct 20 comprises the means of closing 30, the electronic control unit 19 preferably sets the means of closing in the closed position during flight phases. In closed position, the means of closing 30 limits the impact of aerodynamic drag.

### Third Embodiment

In a third embodiment of the cooling device, the cooling device, as shown in FIGS. 8a to 8d, comprises the air inlet 11, the regulator valve 12 and the air stream 13, such as described in the first embodiment.

The cooling device further comprises the air inlet 11b, the regulator valve 12b and the air stream 3b as described in the second embodiment.

Advantageously, the air stream 13b ends, at the air duct 20, in an ejector, which ejects pressurized air into the air duct 20.

In this third embodiment, the electronic control unit 19 sets the regulator valves 12 and 12b according to various input information.

In operation, when the aircraft is in low speed phases (FIGS. 8b and 8c), the thermal discharge from the electrical generator is very large and the aircraft speed is low or zero.

During these low speeds phases, the flow of outside air is low and insufficient for cooling by only the surface cooling means 15.

The electronic control unit 19 sets one of the two regulator valves 12, 12b, substantially into the maximum open position. The two valves cannot both be simultaneously in the open position. When the electronic control unit 19 sets the regulator valve 12 into the open position and the regulator valve 12b into the closed position, the volumetric cooling means 14 is traversed by outside air and pressurized air collected at the compressor. The cooling is performed by both the volumetric cooling means 14 and surface cooling means 15, mainly by the volumetric cooling means 14. When the electronic controller 19 sets the regulator valve 12 into the closed position and the regulator valve 12b into the open position, suction of outside air is created at the exit from the volumetric cooling means 14. The oil cooling is done by both the volumetric cooling means 14 and surface cooling means 15, mainly by the volumetric cooling means 14.

This ensures a heat exchange between the hot volumetric cooling means 14, the outside air and the cold pressurized air, causing the desired cooling of the volumetric cooling means 14 and of the oil circulating within or connected to it by thermal conduction.

As the climb progresses and evolves towards level flight, the speed of the aircraft increases and the outside air temperature decreases. Accordingly, the collection of air at the compressor is reduced by gradual closing of the open regulator valve 12 or 12b controlled by the electronic control unit 19. The oil cooling is performed increasingly, firstly, by the surface cooling means 15 traversed by the outside air and secondly, by the volumetric cooling means 14 traversed by the outside air flowing naturally into the air duct 20.

The closing (and by extension, the opening) of the valves 12,12b is described as being gradual but it is also possible that the closing (and by extension, the opening) of the valves is controlled in an on-or-off manner.

Subsequently, when the aircraft is in steady flight, the cooling is performed normally by the volumetric cooling means 14 and the surface cooling means 15, mainly by the surface cooling means 15, and the regulator valves 12 and 12b then remains closed, thereby eliminating the air collection from the compressor, and therefore reducing the increased fuel consumption that otherwise arises from this power draw.

When the air duct 20 comprises a means of closing 30, the electronic control unit 19 preferably sets the means of closing into closed position during flight phases. In closed position, the means of closing 30 limits the impact of aerodynamic drag.

In a variant of the third embodiment, when the cooling device comprises the oil flow regulator valve, the electronic control unit 19 sets said oil flow regulator valve to direct the flow of oil only to the volumetric cooling means 14. The oil cooling is then performed only by the volumetric cooling means 14 (FIGS. 8b and 8c).

As the climb progresses and evolves towards level flight, the electronic control unit 19 gradually sets the oil flow regulator valve to direct the flow of oil to the surface cooling means 15.

When the aircraft is in steady flight, the cooling is performed only by the surface cooling means 15 (FIG. 8d) and the two regulator valves 12, 12b then remains closed.

When the air duct 20 comprises the means of closing 30, the electronic control unit 19 preferably sets the means of closing in the closed position during flight phases. In closed position, the means of closing 30 limits the impact of aerodynamic drag.

In another variant of this third embodiment, as shown in FIGS. 9a and 9b, the air duct 20 is not open, for example using air inlet 21 means of closing, toward the front of the nacelle 10, so as to reduce the aerodynamic drag caused by the air inlet.

In this embodiment variant, the regulator valve 12b is always in the closed position, during both the low speed phases or in flight.

During the low speed phases, the electronic control unit 19 sets the regulator valve 12 substantially into the maximum open position and pressurized cold air flows through the air duct 20. The volumetric cooling means 14 and surface cooling means 15 are in operation.

When the cooling device comprises the oil flow regulator valve, the electronic control unit 19 sets said oil flow regulator valve to direct the flow of oil to the volumetric cooling means 14. Only the volumetric cooling means 14 is in operation and it is traversed by pressurized air collected at the compressor (shown in FIG. 9a).

When the air duct 20 further comprises the means of closing 30 of the air outlet 22, said means of closing is in the open position.

During the flight phase, the electronic control unit 19 sets the regulator valve 12 into the closed position and the oil cooling is performed only by the surface cooling means 15.

When the cooling device comprises the oil flow regulator valve, the electronic control unit 19 sets said oil flow regulator valve so as to direct the flow of oil to the surface cooling means 15. Only the volumetric cooling means 15 is in operation and it is traversed by outside air (FIG. 9b).

When the air duct 20 comprises the means of closing 30 of the air outlet 22, said means of closing is preferably in the closed position.

The scope of this invention is not limited to the details of the forms of embodiment considered above as an example, but on the contrary extends to modifications in the reach of the man skilled in the art.

The invention is described in the case of a propfan-type propeller, but the invention is also applicable to turbofan-type propellers.

It is apparent from the description that the cooling device allows the engine components to be cooled across all phases, low speed and flight.

The fact of managing the opening and closing of the regulator valves 12, 12b during the low speed phase and in-flight allows the power draw on the compressor to be controlled, and to reduce it whenever possible, which translates into reduced consumption.

1. Aircraft propeller (1) comprising a turbomachine (8) housed in a nacelle (10) and a cooler (45) capable of being traversed by a hot fluid, which is to be cooled by thermal exchange with cold air external to the cooler, the propeller (1) comprising an air stream (13) (13b) capable of directing pressurized air towards an air duct (20) realized between an outer wall (6) and an inner wall (60) of the nacelle (10), the cooler (45) comprising:
volumetric cooling means (14) positioned in the air duct (20),
surface cooling means (15), unrelated to said volumetric cooling means, arranged at an outer wall of the aircraft,
wherein the air duct (20) comprises an air inlet (21) arranged substantially forward of the propeller (1) nacelle (10).

2. Aircraft propeller according to claim 1, wherein:
the surface cooling means (15) is sized so as to be sufficient to ensure the desired cooling by itself when the aircraft is in flight, within preselected environmental and speed conditions,
the volumetric cooling means (14) is sized so as to be sufficient to ensure the desired cooling by itself when the aircraft is at low or zero speed, within preselected environmental conditions.

3. Aircraft propeller according to any one of the preceding claims, wherein a pressurized air inlet (11) is arranged at a 1^{st} stage of an air compressor of the turbomachine (8) and in that the associated air stream (13) emerges upstream of the volumetric cooling means (14).

4. Aircraft propeller according to any one of claims 1 to 2, wherein a pressurized air inlet (11b) is located downstream from an air compressor of the turbomachine (8) and in that the associated air stream (13b) emerges downstream from the volumetric cooling means (14).

5. Aircraft propeller according to claim 4, wherein the air stream (13b) comprises, at the air duct (20), an ejector, which ejects pressurized air into said air duct.

6. Aircraft propeller according to any one of claims 1 to 2, comprising two air streams (13, 13b) and a valve (12, 12b) associated with each stream, an air stream (13) emerging upstream of the cooler (14) and an air stream (13b) emerging downstream from the cooler, the valves (12,12b) controlling the entry of pressurized air according to one air stream or the other.

7. Aircraft propeller according to any one of the preceding claims, wherein the surface cooling means (15) is installed at the outer wall (6) of the nacelle (10) or at an outer wall (101) of a mounting pylon (100) of said propeller.

8. Aircraft propeller according to any one of the preceding claims, wherein the surface cooling means (15) is a set of fins extending from the outer wall (6, 101) and directed primarily parallel to the direction of airflow when the aircraft is on the ground.

9. Aircraft comprising a propeller according to any one of the preceding claims.
